(19) United States
(12) Patent Application Publication
(10) Pub. No.: US 2026/0155912 A1
(43) Pub. Date: Jun. 4, 2026

(54) APPARATUS AND METHOD FOR ENCODING AND RETRANSMISSION OF LOW DENSITY PARITY CHECK CODES IN WIRELESS COMMUNICATION SYSTEM

(71) Applicant: ELECTRONICS AND TELECOMMUNICATIONS RESEARCH INSTITUTE, Daejeon (KR)

(72) Inventors: Jung Im KIM, Daejeon (KR); Young Jo KO, Daejeon (KR); Hee Sang CHUNG, Daejeon (KR); Yong Seouk CHOI, Daejeon (KR)

(73) Assignee: ELECTRONICS AND TELECOMMUNICATIONS RESEARCH INSTITUTE, Daejeon (KR)

(21) Appl. No.: 19/402,562

(22) Filed: Nov. 26, 2025

(30) Foreign Application Priority Data
Nov. 29, 2024 (KR) 10-2024-0174736
Nov. 5, 2025 (KR) 10-2025-0165663

(51) Int. Cl. H04L 1/00; H04L 1/18

(52) U.S. Cl. CPC H04L 1/0057; H04L 1/0045; H04L 1/0071; H04L 1/18

(57) ABSTRACT

The present disclosure relates generally to wireless communication systems, and more particularly, to an apparatus and method for encoding and retransmission of low density parity check codes in wireless communication systems. A method of operating a transmitting apparatus according to the present disclosure inputs systematic bits to a first LDPC encoder to perform first encoding to generate first parity bits and stores them in a first circular buffer, interleaves the systematic bits through an interleaver to generate interleaved systematic bits, and inputs the interleaved systematic bits to a second LDPC encoder to perform second encoding to generate second parity bits and stores them in a second circular buffer.

### CROSS REFERENCE TO RELATED APPLICATION

This application claims priority to Korean Patent Application No. 10-2024-0174736, filed on Nov. 29, 2024, and Korean Patent Application No. 10-2025-0165663, filed on Nov. 5, 2025, the entire contents of which are hereby incorporated by reference.

### BACKGROUND OF THE INVENTION

### Field of the Invention

The present disclosure relates generally to wireless communication systems, and more particularly, to an apparatus and method for encoding and retransmission of Low Density Parity Check (LDPC) codes in wireless communication systems.

### Description of the Related Art

In the 3GPP 5G NR (New Radio) system, LDPC (Low Density Parity Check) codes have been adopted as a standard technology for data channels (PDSCH, PUSCH) as a channel coding scheme to overcome wireless channel errors. The output code word (C) of an LDPC code encoder consists of a set of systematic bits (Cs) and parity bits (Cp). The LDPC parity check matrix H and the code word are encoded with the relationship HC\hat{ }T.

The systematic bits are information bits input to the encoder, and each parity bit is represented by an XOR (exclusive OR) operation between systematic bits according to elements of the parity check matrix H. That is, each parity bit is obtained by selecting some bits among the systematic bits when the parity check matrix H has a value of 1, and not selecting when it has a value of 0, and performing XOR operation on the selected systematic bits. At the receiving side decoder, the determination of 1 or 0 for each systematic bit is performed by repeatedly exchanging and propagating information about the LLR (Log Likelihood Ratio) value for each systematic bit and the LLR value for the systematic bit provided by parity bits related to the systematic bit in relation to the parity check matrix H.

This process of exchanging and propagating information about LLR values for systematic bits is called belief propagation. If the number of parity bits is increased to increase belief propagation, the code rate decreases and the channel coding gain can increase. The transmitting side adds CRC (Cyclic Redundancy Check) bits to data to be encoded with LDPC codes, performs encoding and transmits the data. The receiving side performs decoding and reports the CRC check result. If the CRC check result indicates an error, the transmitting side performs retransmission using the IR (Incremental Redundancy) HARQ (Hybrid Automatic Repeat Request) scheme.

The 5G NR IR HARQ scheme transmits different encoded parity bits in the second and fourth transmissions compared to the first transmission, so that when decoding retransmitted data after the first transmission among the data encoded with LDPC codes, the code rate decreases and the range of belief propagation increases, thereby increasing the coding gain. In the case of the third transmission, some parity bits and systematic bits are transmitted. The parity check matrix of the LDPC code in 5G NR consists of two base graphs (matrices). Which base graph to use among the two base matrices BG1 and BG2 (Base Graph, BG) is determined according to the transport block length, which is the data length input from the upper layer to the physical layer in 5G NR, and the code rate. BG1 consists of 46 rows and 68 columns, and BG2 consists of 42 rows and 52 columns. In the conventional 5G NR LDPC retransmission scheme, the starting position of the encoded data in the circular buffer to be transmitted is determined according to the redundancy version identifier (rvid). The rvid identifies retransmission data and includes information about the transmission order.

In the specification, the default transmission order is RV0, RV2, RV3, RV1. Transmissions including systematic bits are RV0 and RV3 transmissions, and RV1 and RV2 transmissions consist only of parity bits. RV0 includes all systematic bits, and RV3 includes some systematic bits. Following the default transmission, each of the first transmission and the third transmission data at the receiving side can be self-decoded without using previously transmitted data, but the second transmission and the fourth transmission data can only be decoded when using previously received data. In 3GPP NR, standard work is being conducted by classifying the frequency domain into FR1 (Frequency Range 1) and FR2 (Frequency Range 2). FR2 is a higher frequency environment than FR1, and the wireless channel conditions are worse, resulting in worse cell edge throughput and reliability.

That is, in the wireless channel environment of FR1 frequency, when electromagnetic waves encounter obstacles, they can create multiple paths through phenomena such as diffraction and propagate. However, in high frequency wireless channel environments such as FR2, the diffraction of electromagnetic waves decreases, and when they encounter obstacles, they are more likely to be blocked without creating multiple paths, and propagation loss increases, reducing the communication range between transceivers. 3GPP has adopted multi-TRP (multiple Transmission-Reception-Point) transmission as a standard technology to reduce link failure probability and compensate for propagation loss in wireless channel environments with high propagation blocking probability, such as cell edges where channel conditions are poor. However, the conventional scheme assumes that even if an error occurs in the CRC check of the first transmission, the error is not severe enough to be used in decoding with retransmitted data. In environments with high propagation blocking probability due to obstacles, if the receiving end fails to receive the first systematic bits transmission (RV0) due to propagation blocking after transmission from the transmitting side, and receives the second transmitted (RV2) parity bits, decoding is impossible with only the second parity bits because the first systematic bits are blocked. The third transmission packet consisting of parity bits and systematic bits can be decoded, but decoding is not possible with only the fourth transmitted (RV1) parity bits. Therefore, there is a problem that unnecessary retransmissions occur in propagation blocking situations, degrading throughput.

### SUMMARY OF THE INVENTION

Based on the above discussion, the present disclosure provides an apparatus and method for enabling self-decoding of physical layer retransmission data even in environments with high propagation blocking probability in wireless communication systems.

In addition, the present disclosure provides an apparatus and method for improving channel coding gain by increasing the gain of belief propagation in wireless communication systems. In addition, the present disclosure provides an apparatus and method for improving throughput by preventing unnecessary retransmissions in wireless communication systems. In addition, the present disclosure provides an apparatus and method for providing an efficient LDPC code retransmission scheme utilizing an interleaver in a multi-transmission point environment in wireless communication systems.

According to various embodiments of the present disclosure, a method of operating a transmitting apparatus for retransmitting data encoded with a low density parity check code in a wireless communication system includes:
inputting systematic bits to a first LDPC encoder to perform first encoding to generate first parity bits and store them in a first circular buffer; interleaving the systematic bits through an interleaver to generate interleaved systematic bits; inputting the interleaved systematic bits to a second LDPC encoder to perform second encoding to generate second parity bits and store them in a second circular buffer; in even-numbered transmissions, transmitting data including systematic bits and first parity bits from the first circular buffer and setting a circular buffer starting point to enable self-decoding at the receiving side; and in odd-numbered transmissions, transmitting data including interleaved systematic bits and second parity bits from the second circular buffer and setting a circular buffer starting point to enable self-decoding at the receiving side.

According to various embodiments of the present disclosure, a method of operating a receiving apparatus for receiving data encoded with a low density parity check code in a wireless communication system includes: receiving first received data including systematic bits and first parity bits in an even-numbered transmission; decoding the first received data through a first LDPC decoder to obtain a first LLR value for the systematic bits; interleaving the first LLR value through an interleaver when a CRC check result of the first received data indicates an error; receiving second received data including interleaved systematic bits and second parity bits in an odd-numbered transmission; and inputting the second received data and the interleaved first LLR value to a second LDPC decoder to perform decoding.

According to various embodiments of the present disclosure, a method of operating a transmitting apparatus for transmitting data encoded with a low density parity check code using multiple transmission points in a wireless communication system includes: at a first transmission point, inputting systematic bits to a first LDPC encoder to perform first encoding to generate first parity bits and store them in a first circular buffer; at a second transmission point, interleaving the systematic bits through an interleaver to generate interleaved systematic bits; at the second transmission point, inputting the interleaved systematic bits to a second LDPC encoder to perform second encoding to generate second parity bits and store them in a second circular buffer; and transmitting data from the first circular buffer at the first transmission point and transmitting data from the second circular buffer at the second transmission point, wherein a circular buffer starting point is set to enable self-decoding at the receiving side for data transmitted from each transmission point.

According to various embodiments of the present disclosure, a method of operating a receiving apparatus for receiving data encoded with a low density parity check code from multiple transmission points in a wireless communication system includes: receiving first received data including systematic bits and first parity bits from a first transmission point; decoding the first received data through a first LDPC decoder to obtain a first LLR value for the systematic bits; receiving second received data including interleaved systematic bits and second parity bits from a second transmission point; decoding the second received data through a second LDPC decoder to obtain a second LLR value for the interleaved systematic bits; and performing belief propagation by interleaving the first LLR value through an interleaver and inputting it to the second LDPC decoder, or deinterleaving the second LLR value through a deinterleaver and inputting it to the first LDPC decoder.

The apparatus and method according to various embodiments of the present disclosure enable preventing unnecessary retransmissions and improving throughput even in propagation blocking situations by setting the starting point of the circular buffer so that self-decoding is possible with each transmission data even during retransmission. In addition, the apparatus and method according to various embodiments of the present disclosure enable expanding the belief propagation range and increasing channel coding gain by generating different parity bits using an interleaver. Effects obtainable from the present disclosure are not limited to the effects mentioned above, and other effects not mentioned will be clearly understood by those of ordinary skill in the art to which the present disclosure belongs from the description below.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a graph showing the base graph selection criteria for LDPC codes according to various embodiments of the present disclosure.

FIG. 2 is a diagram showing the circular buffer structure and transmission starting points for each retransmission version of the prior art according to various embodiments of the present disclosure.

FIG. 3 is a diagram showing the detailed structure of transmission starting points in a circular buffer according to various embodiments of the present disclosure.

FIG. 4 is a diagram showing the circular buffer structure and transmission starting points at one transmission point according to an embodiment of the present disclosure.

FIG. 5 is a table showing circular buffer transmission starting points for IR HARQ operation at one transmission point according to an embodiment of the present disclosure.

FIG. 6 is a diagram showing the overall system structure of multiple transmission points according to an embodiment of the present disclosure.

FIG. 7 is a table showing circular buffer transmission starting points for IR HARQ operation at multiple transmission points according to an embodiment of the present disclosure.

FIG. 8 is a flowchart showing the operation method of a transmitting apparatus at one transmission point according to an embodiment of the present disclosure.

FIG. 9 is a flowchart showing the operation method of a receiving apparatus at one transmission point according to an embodiment of the present disclosure.

FIG. 10 is a flowchart showing the operation method of a transmitting apparatus at multiple transmission points according to an embodiment of the present disclosure.

FIG. 11 is a flowchart showing the operation method of a receiving apparatus at multiple transmission points according to an embodiment of the present disclosure.

FIG. 12 is a block diagram showing the internal configuration of a transmitting apparatus and a receiving apparatus according to an embodiment of the present disclosure.

### DETAILED DESCRIPTION OF THE INVENTION

Terms used in the present disclosure are merely used to describe specific embodiments and may not be intended to limit the scope of other embodiments. Singular expressions may include plural expressions unless the context clearly indicates otherwise. Technical or scientific terms used herein may have the same meanings as commonly understood by one of ordinary skill in the technical field described in the present disclosure. Among terms used in the present disclosure, terms defined in general dictionaries may be interpreted as having meanings identical or similar to those in the context of related art, and are not interpreted as ideal or excessively formal meanings unless explicitly defined in the present disclosure. In some cases, even terms defined in the present disclosure cannot be interpreted to exclude embodiments of the present disclosure.

In various embodiments of the present disclosure described below illustrate hardware-based approaches as examples. However, since various embodiments of the present disclosure include technologies using both hardware and software, various embodiments of the present disclosure do not exclude software-based approaches.

In addition, in the detailed description and claims of the present disclosure, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

The present disclosure relates to an apparatus and method for encoding and retransmission of low density parity check codes in wireless communication systems.

Specifically, the present disclosure describes a technology for increasing channel coding gain by setting the starting point of a circular buffer so that self-decoding is possible for each retransmission data even in environments with high propagation blocking probability in wireless communication systems, and expanding the belief propagation range by utilizing an interleaver.

Terms referring to signals, terms referring to channels, terms referring to control information, terms referring to network entities, and terms referring to components of devices used in the following description are exemplified for convenience of description. Therefore, the present disclosure is not limited to the terms described below, and other terms with equivalent technical meanings may be used.

In addition, although the present disclosure describes various embodiments using terms used in some communication standards (e.g., 3GPP (3rd Generation Partnership Project)), this is merely an example for explanation. Various embodiments of the present disclosure can be easily modified and applied to other communication systems as well.

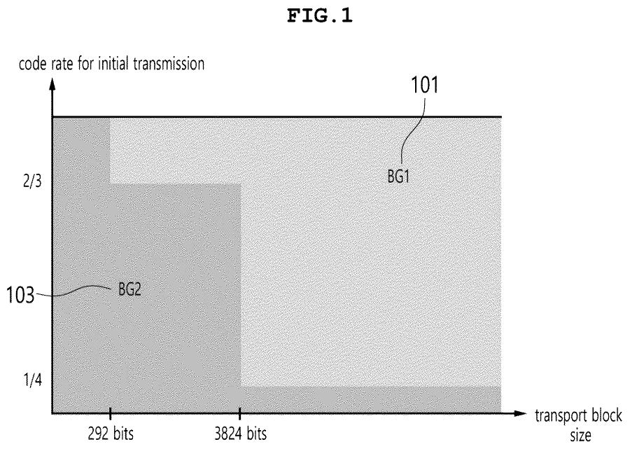

FIG. 1 is a graph showing the base graph selection criteria for LDPC codes according to various embodiments of the present disclosure.

Referring to FIG. 1, the horizontal axis represents the transport block size, and the vertical axis represents the code rate for initial transmission.

Region 101 represents the region where LDPC base graph 1 (BG1) is selected. BG1 consists of 46 rows and 68 columns, and is selected when the transport block length is greater than 3824 bits, or when the transport block length is between 292 bits and 3824 bits and the first transmission code rate is greater than 2/3.

Region 103 represents the region where LDPC base graph 2 (BG2) is selected. BG2 consists of 42 rows and 52 columns, and is selected when the transport block length is 292 bits or less, or when the transport block length is between 292 bits and 3824 bits and the first transmission code rate is 2/3 or less.

In the 5G NR system, efficient channel coding can be performed by selecting an appropriate base graph according to the transport block length and code rate.

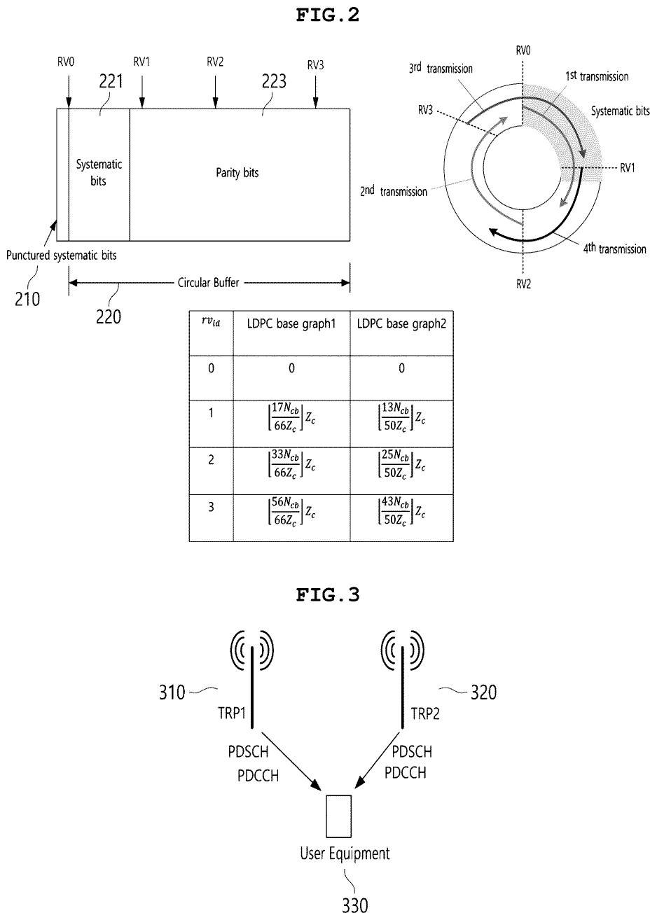

FIG. 2 is a diagram showing the circular buffer structure and transmission starting points for each retransmission version of the prior art according to various embodiments of the present disclosure.

FIG. 2 is a diagram showing the circular buffer structure and transmission starting points for each retransmission version of the prior art.

Referring to FIG. 2, the rectangular structure on the left is a linear representation of the circular buffer 220, consisting of a systematic bits region 221 and a parity bits region 223. Part of the systematic bits region may be punctured systematic bits 219 that are not transmitted.

The position where data transmission starts in the circular buffer is determined according to the redundancy version identifier (rvid). RV0, RV1, RV2, and RV3 represent starting points according to each transmission order. In the conventional default transmission order, systematic bits are included only in RV0 and RV3 transmissions, and RV1 and RV2 transmissions consist mainly of parity bits. In contrast, the present disclosure makes systematic bits included in every transmission by setting the circular buffer starting point and operating two paths (non-interleaved/interleaved), enabling independent decoding (self-decoding) for each transmission.

The circular diagram on the right represents the conceptual structure of the circular buffer. The first transmission (1st transmission) starts at RV0 and includes systematic bits 221. The second transmission (2nd transmission) starts at RV1 and mainly includes parity bits. The third transmission (3rd transmission) starts at RV2, and the fourth transmission (4th transmission) starts at RV3.

The table at the bottom shows the starting point of the circular buffer according to each rvid value. When rvid is 0, the starting point is 0. When rvid is 1, 2, or 3, the starting point is determined by different calculation formulas according to LDPC base graph 1 and base graph 2, respectively. Here, Ncb is the number of bits that go into the circular buffer, and Zc is a value determined according to the number of information bits to be encoded and the code rate.

FIG. 3 is a diagram showing the detailed structure of transmission starting points in a circular buffer according to various embodiments of the present disclosure.

Referring to FIG. 3, a structure in which a first transmission point 310 and a second transmission point 320 transmit data to a terminal 330 is shown.

The first transmission point 310 is indicated as TRP1 and can transmit signals to the terminal 330 through PDSCH (Physical Downlink Shared Channel) and PDCCH (Physical Downlink Control Channel). The second transmission point 320 is indicated as TRP2 and can also transmit signals to the terminal 330 through PDSCH and PDCCH.

The terminal 330 is indicated as UE (User Equipment) and can receive signals from two transmission points. The multi-transmission point transmission scheme is used to reduce link failure probability and compensate for propagation loss in environments with high propagation blocking probability, such as high-frequency environments like FR2 or cell edges.

When transmission from one transmission point is blocked, some retransmission versions (e.g., RV1, RV2) consist only of parity bits, making self-decoding impossible. To solve this problem, the present disclosure proposes a new retransmission scheme that enables self-decoding for each transmission.

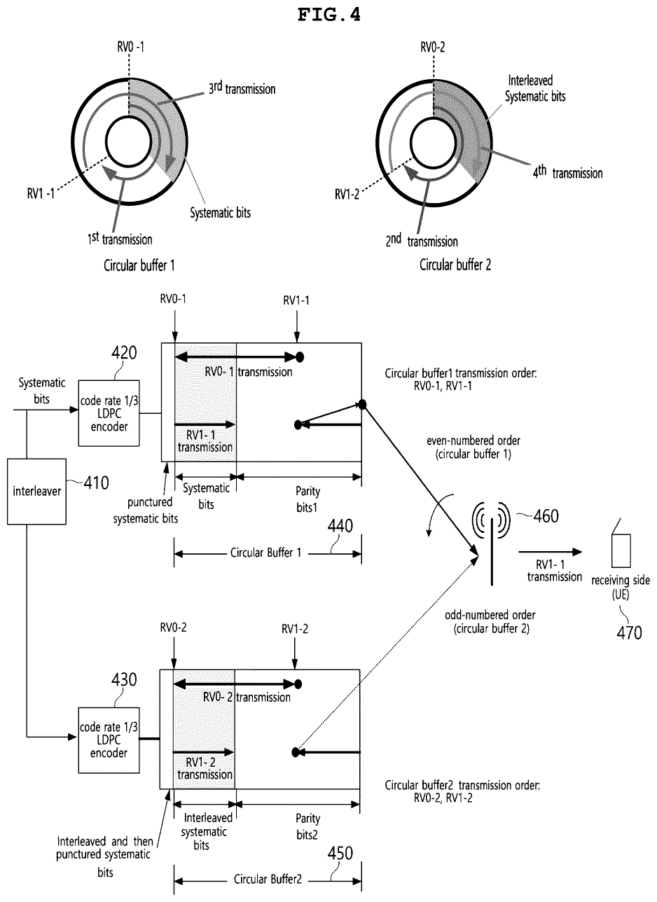

FIG. 4 is a diagram showing the circular buffer structure and transmission starting points at one transmission point according to an embodiment of the present disclosure.

Referring to FIG. 4, systematic bits are input and processed through two paths. In the upper path, systematic bits are directly input to the code rate 1/3 LDPC encoder 420 without going through an interleaver and stored in circular buffer 1 (440).

Circular buffer 1 (440) consists of punctured systematic bits, systematic bits, and parity bits 1. The circular diagram at the top shows the transmission order of circular buffer 1, where the first transmission (1st transmission) starts at RV0-1, and the third transmission (3rd transmission) starts at RV1-1. In the lower path, systematic bits are interleaved through the interleaver 410, then input to the code rate 1/3 LDPC encoder 430 and stored in circular buffer 2 (450). Circular buffer 2 (450) consists of interleaved and then punctured systematic bits, interleaved systematic bits, and parity bits 2.

The circular diagram at the bottom shows the transmission order of circular buffer 2, where the second transmission (2nd transmission) starts at RV0-2, and the fourth transmission (4th transmission) starts at RV1-2. Odd-numbered transmissions (first and third transmissions) are performed from circular buffer 1 (440), and even-numbered transmissions (second and fourth transmissions) are performed from circular buffer 2 (450). Data is transmitted through the transmission point (460) and reaches the receiving side (470). Data is transmitted through the transmission point (460) and reaches the receiving side (470).

In the present disclosure, the starting point of the circular buffer is set so that both systematic bits and parity bits are included in each transmission, configured to enable self-decoding with each transmission data alone. In addition, since the two LDPC encoders (420, 430) generate different parity bits using the interleaver (410), the belief propagation range is expanded and the coding gain increases.

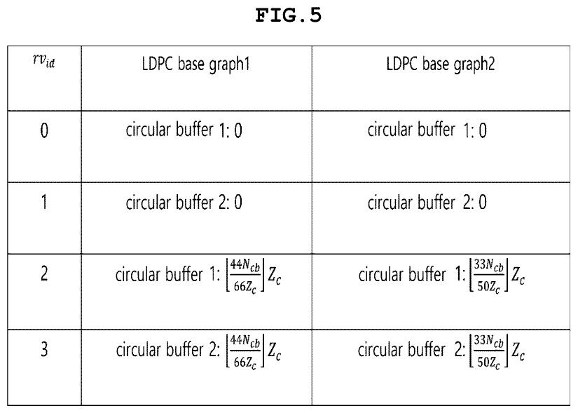

FIG. 5 is a table showing circular buffer transmission starting points for IR HARQ operation at one transmission point according to an embodiment of the present disclosure.

Referring to FIG. 5, the transmission starting point of each circular buffer according to the redundancy version identifier (rvid) is defined.

When rvid is 0, the starting point of circular buffer 1 is 0, and the starting point of circular buffer 2 is also 0. This corresponds to the first transmission and the second transmission.

When rvid is 1, the starting point of circular buffer 2 is 0. This represents the position in the retransmission order.

When rvid is 2, for LDPC base graph 1, the starting point of circular buffer 1 is └(44Ncb)/(66Zc)┘Zc, and for LDPC base graph 2, the starting point of circular buffer 1 is └(33Ncb)/(50Zc)┘Zc. This corresponds to the third transmission.

When rvid is 3, for LDPC base graph 1, the starting point of circular buffer 2 is └(44Ncb)/(66Zc)┘Zc, and for LDPC base graph 2, the starting point of circular buffer 2 is └(33Ncb)/(50Zc)┘Zc. This corresponds to the fourth transmission (Ncb is the number of bits in the circular buffer, and Zc is a value determined by the number of information bits and the code rate).

Here, Ncb is the number of bits that go into the circular buffer, and Zc is a value determined according to the number of information bits to be encoded and the code rate. The circular buffer starting point setting method of the present disclosure is configured to enable self-decoding by including both systematic bits and parity bits for each transmission.

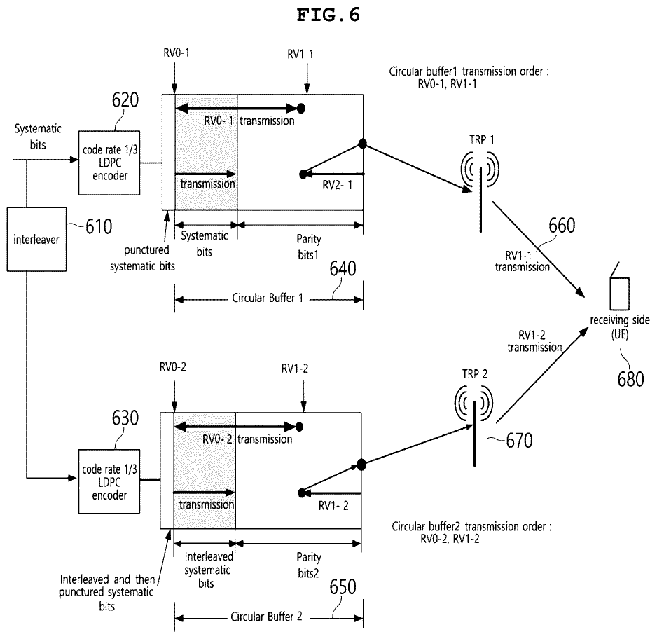

FIG. 6 is a diagram showing the overall system structure of multiple transmission points according to an embodiment of the present disclosure.

Referring to FIG. 6, systematic bits are input and processed separately to two transmission points. On the left side, an interleaver 610 and two code rate 1/3 LDPC encoders (620, 630) are located. In the upper path, systematic bits are directly input to the code rate 1/3 LDPC encoder 620 without going through an interleaver and stored in circular buffer 1 (Circular Buffer 1). In the lower path, systematic bits are interleaved through the interleaver 610, then input to the code rate 1/3 LDPC encoder 630 and stored in circular buffer 2 (Circular Buffer 2).

The first transmission point 640 is indicated as TRP1 and transmits data from circular buffer 1. The transmission order of circular buffer 1 is indicated as RV0-1 and RV1-1. The second transmission point 660 is indicated as TRP2 and transmits data from circular buffer 2 (650). The transmission order of circular buffer 2 is indicated as RV0-2 and RV1-2. Throughout this text and figures, the transmission starting point notation is consistently used as RV0-1/RV1-1 (buffer 1), RV0-2/RV1-2 (buffer 2).

The receiving side 670 is indicated as a terminal (receiving side (UE)) and can receive both transmission 680 from TRP1 (640) and transmission from TRP2 (660). In the multi-transmission point scheme of the present disclosure, TRP1 transmits data encoded with non-interleaved systematic bits, and TRP2 transmits data encoded with interleaved systematic bits. Since the parity bits generated at the two transmission points are different due to the interleaver 610, the code rate is lowered and the channel coding gain increases. In addition, data transmitted from each transmission point includes both systematic bits and parity bits, enabling independent decoding. Through this, even if the signal from one transmission point is blocked, decoding is possible with only the signal from the other transmission point, ensuring stable communication even in environments with high propagation blocking probability.

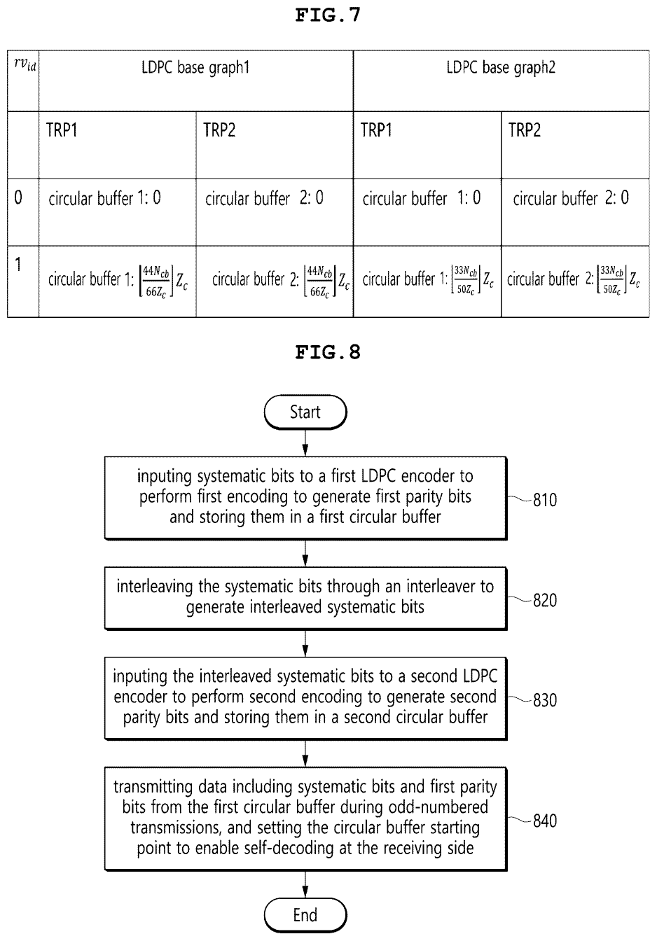

FIG. 7 is a table showing circular buffer transmission starting points for IR HARQ operation at multiple transmission points according to an embodiment of the present disclosure.

Referring to FIG. 7, the circular buffer transmission starting point of each transmission point (TRP1, TRP2) according to the redundancy version identifier (rvid) is defined.

When rvid is 0, the starting point of circular buffer 1 of TRP1 is 0, and the starting point of circular buffer 2 of TRP2 is also 0. This is applied identically for both LDPC base graph 1 and base graph 2. In this case, each transmission point transmits data from the beginning of the circular buffer.

When rvid is 1, for LDPC base graph 1, the starting point of circular buffer 1 of TRP1 is └(44Ncb)/(66Zc)┘Zc, and the starting point of circular buffer 2 of TRP2 is also └(44Ncb)/(66Zc)┘Zc. For LDPC base graph 2, the starting point of circular buffer 1 of TRP1 is └(33Ncb)/(50Zc)┘Zc, and the starting point of circular buffer 2 of TRP2 is also └(33Ncb)/(50Zc)┘Zc.

Here, Ncb is the number of bits that go into the circular buffer, and Zc is a value determined according to the number of information bits to be encoded and the code rate.

In the multi-transmission point scheme of the present disclosure, each transmission point uses a different circular buffer (TRP1 uses circular buffer 1, TRP2 uses circular buffer 2), but applies the same starting point calculation formula for the same rvid. Through this, data transmitted from each transmission point includes both systematic bits and parity bits, enabling independent decoding, and even if the signal from one transmission point is blocked, decoding is possible with only the signal from the other transmission point.

FIG. 8 is a flowchart showing the operation method of a transmitting apparatus at one transmission point according to an embodiment of the present disclosure.

Referring to FIG. 8, the transmitting apparatus operates in the following steps.

In step 810, the transmitting apparatus inputs systematic bits to a first LDPC encoder to perform first encoding to generate first parity bits and stores them in a first circular buffer. The first circular buffer stores systematic bits and first parity bits, and some systematic bits may be punctured. The first LDPC encoder generates parity bits from systematic bits based on the LDPC parity check matrix. The generated parity bits are calculated through XOR operations between systematic bits and are used for belief propagation decoding at the receiving side.

In step 820, the transmitting apparatus interleaves the systematic bits through an interleaver to generate interleaved systematic bits. The interleaver rearranges the order of the systematic bits so that different parity bits are generated in the next step. Since the positions of the systematic bits are changed through interleaving, new parity bit combinations are generated in relation to the LDPC parity check matrix.

In step 830, the transmitting apparatus inputs the interleaved systematic bits to a second LDPC encoder to perform second encoding to generate second parity bits and stores them in a second circular buffer. The second LDPC encoder uses the same LDPC parity check matrix as the first LDPC encoder, but since the order of the input systematic bits is interleaved, second parity bits different from the first parity bits are generated. Through this, two different parity bit sets are generated for the same systematic bits, and during retransmission, the belief propagation range is expanded and the channel coding gain increases.

In step (840), in an odd-numbered transmission, the transmitting apparatus transmits, from the first circular buffer, data including the systematic bits and the first parity bits, and sets the starting point of the circular buffer so that self-decoding at the receiving side is possible. Because both the systematic bits and the parity bits are included, the receiving side can be decoded independently without previous transmission data. Even-numbered transmissions include the second transmission (2nd, rvid=1) and the fourth transmission (4th, rvid=3), and odd-numbered transmissions include the first transmission (1st, rvid=0) and the third transmission (3rd, rvid=2). The second transmission (rvid=1) is transmitted from starting point 0 of circular buffer 2, and the fourth transmission (rvid=3) is transmitted from a starting point calculated according to the LDPC base graph in circular buffer 2. Each transmission includes both systematic bits and parity bits, enabling independent decoding at the receiving side without previous transmission data.

In step (840), in an even-numbered transmission, the transmitting apparatus transmits, from the second circular buffer, data including the interleaved systematic bits and the second parity bits, and sets the starting point of the circular buffer so that self-decoding at the receiving side is possible. An odd-numbered transmission also includes the interleaved systematic bits and the parity bits, thereby enabling independent decoding. Odd-numbered transmissions include the first transmission (1st, rvid=0) and the third transmission (3rd, rvid=2), and even-numbered transmissions include the second transmission (2nd, rvid=1) and the fourth transmission (4th, rvid=3). The first transmission (rvid=0) is transmitted from starting point 0 of circular buffer 1, and the third transmission (rvid=2) is transmitted from a starting point calculated according to the LDPC base graph in circular buffer 1. Odd-numbered transmissions also include interleaved systematic bits and parity bits, enabling independent decoding.

In one embodiment, the code rate of data stored in the first circular buffer and the second circular buffer may be 1/3. During transmission, the effective code rate is set to 1/2 by partially selecting the system/parity combination to achieve a self-decodable configuration for each transmission. This means encoding at a low code rate by generating a sufficient amount of parity bits relative to the systematic bits. On the other hand, the code rate of the data actually transmitted may be set to 1/2. This means increasing transmission efficiency by selecting and transmitting some data from the circular buffer while including a level of parity bits that enables self-decoding.

In another embodiment, the transmitting apparatus may determine that the propagation blocking probability is high based on at least one of RSSI (Received Signal Strength Indicator), RSRP (Reference Signal Received Power), RSRQ (Reference Signal Received Quality), SINR (Signal to Interference plus Noise Ratio), or handover failure information. In environments with high propagation blocking probability, the retransmission scheme of the present disclosure can be applied to enable self-decoding for each transmission, thereby preventing unnecessary retransmissions and improving throughput.

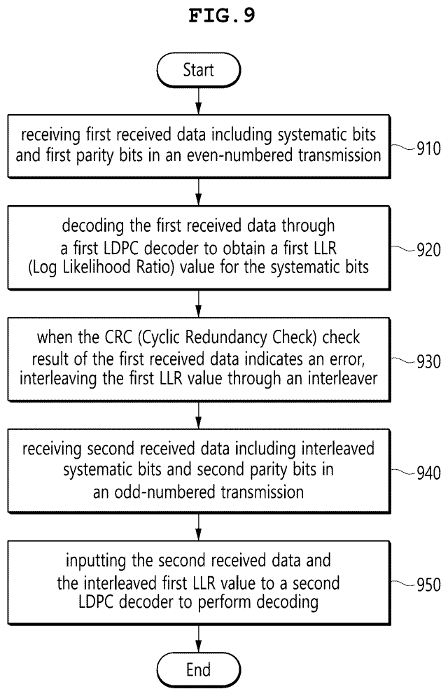

In yet another embodiment, the transmitting apparatus may be a base station of the 3GPP 5G NR system and may transmit data through PDSCH (Physical Downlink Shared Channel) or PUSCH (Physical Uplink Shared Channel). The transmitting apparatus includes a transceiver and a processor, and the processor may be configured to perform the above steps. FIG. 9 is a flowchart showing the operation method of a receiving apparatus at one transmission point according to an embodiment of the present disclosure.

FIG. 9 is a flowchart showing the operation method of a receiving apparatus at one transmission point according to an embodiment of the present disclosure.

Referring to FIG. 9, the receiving apparatus operates in the following steps.

In step (910), in an even-numbered transmission, the receiving apparatus receives first received data including the systematic bits and the first parity bits. The receiving apparatus may receive the first received data through PDSCH or PUSCH. Odd-numbered transmissions include the first transmission (rvid=0) or the third transmission (rvid=2). The first received data is transmitted from the first circular buffer at the transmitting side and includes non-interleaved systematic bits and corresponding first parity bits. The receiving apparatus may receive the first received data through PDSCH or PUSCH.

In step 920, the receiving apparatus decodes the first received data through a first LDPC decoder to obtain a first LLR (Log Likelihood Ratio) value for the systematic bits. The first LDPC decoder performs a belief propagation algorithm based on the LDPC parity check matrix. During the decoding process, an LLR value is calculated for each systematic bit, which represents information about the probability that the bit is 0 or 1. LLR value information provided by parity bits related to the systematic bit is repeatedly exchanged and propagated, improving the reliability of each bit.

In step 930, when the CRC (Cyclic Redundancy Check) check result of the first received data indicates an error, the receiving apparatus interleaves the first LLR value through an interleaver. The CRC check is used to determine whether the decoded data has errors. In case of a CRC error, the first LLR value is interleaved and used for decoding the next transmission, and the procedure is terminated if the CRC of that transmission is normal. Conversely, the LLR obtained from the odd transmission is deinterleaved and exchanged as input to the even transmission decoder. However, when the CRC check result indicates an error, the first LLR value is interleaved and used for decoding the second received data to be received in the next transmission. The interleaved first LLR value is rearranged to match the order of the interleaved systematic bits at the transmitting side.

In step (940), in an odd-numbered transmission, the receiving apparatus receives second received data including the interleaved systematic bits and the second parity bits. The second received data is transmitted from the second circular buffer at the transmitting side, and includes the interleaved systematic bits and the corresponding second parity bits. even-numbered transmissions include the second transmission (rvid=1) or the fourth transmission (rvid=3). The second received data is transmitted from the second circular buffer at the transmitting side and includes interleaved systematic bits and corresponding second parity bits.

In step 950, the receiving apparatus inputs the second received data and the interleaved first LLR value to a second LDPC decoder to perform decoding. The second LDPC decoder performs decoding by combining the LLR value obtained from the second received data and the interleaved first LLR value from step 930. Since the interleaved first LLR value provides reliability information about the systematic bits obtained from the previous transmission, it improves the decoding performance of the second decoder. Through this, the belief propagation range is expanded and the reliability of each systematic bit increases.

In one embodiment, a second LLR value for the systematic bits may be obtained as a result of decoding by the second LDPC decoder. When the CRC check result of the second received data indicates an error, the second LLR value may be deinterleaved through a deinterleaver to restore the original systematic bit order. The deinterleaved second LLR value may be input to the first LDPC decoder and used to improve reliability when decoding the next transmission data. Through this exchange of LLR values, belief propagation is expanded between the first decoder and the second decoder, improving overall decoding performance.

In another embodiment, each of the first received data and the second received data can be independently decoded without using previously received data. Since each transmission data includes both systematic bits and parity bits, self-decoding is possible with only the currently received data even when previous transmission data is not received due to propagation blocking. Through this, stable data reception is possible even in environments with high propagation blocking probability. As an example of an application trigger, the terminal can determine the propagation blocking probability using at least one of RSSI, RSRP, RSRQ, and SINR.

In yet another embodiment, the receiving apparatus may be a terminal (UE) of the 3GPP 5G NR system and includes a transceiver and a processor. The processor may include or be configured to perform the functions of a first LDPC decoder, a second LDPC decoder, an interleaver, and a deinterleaver. The receiving apparatus may operate in FR1 or FR2 frequency bands, and communication reliability can be greatly improved by applying the method of the present disclosure, especially in environments with high propagation blocking probability, such as high-frequency environments like FR2 or cell edges.

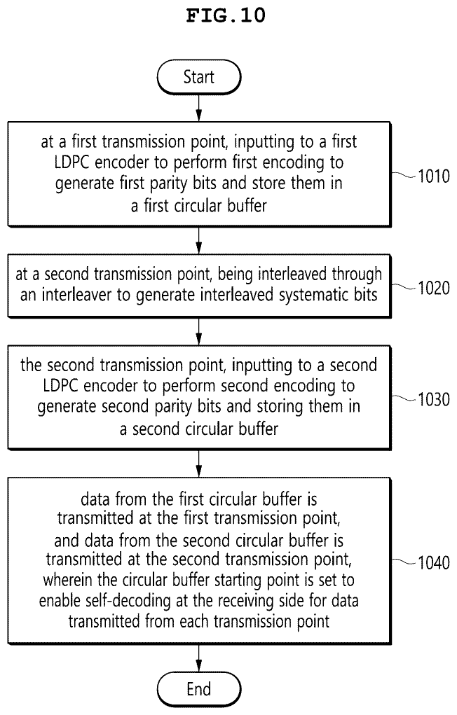

FIG. 10 is a flowchart showing the operation method of a transmitting apparatus at multiple transmission points according to an embodiment of the present disclosure.

Referring to FIG. 10, the transmitting apparatus operates in the following steps.

In step 1010, at a first transmission point, systematic bits are input to a first LDPC encoder to perform first encoding to generate first parity bits and store them in a first circular buffer. The first transmission point may be referred to as TRP1 and may be the first transmission reception point of the base station. The first LDPC encoder receives systematic bits in the original order without interleaving and generates first parity bits according to the LDPC parity check matrix. The generated first parity bits are stored in the first circular buffer together with the systematic bits, and some systematic bits may be punctured. The first circular buffer can store data encoded at a code rate of 1/3.

In step 1020, at a second transmission point, the systematic bits are interleaved through an interleaver to generate interleaved systematic bits. The second transmission point may be referred to as TRP2 and may be the second transmission reception point of the base station. The interleaver rearranges the order of the systematic bits so that parity bits different from those of the first transmission point are generated in relation to the LDPC parity check matrix. The interleaving pattern can be implemented in various ways, such as pseudo-random or block interleaving.

In step 1030, at the second transmission point, the interleaved systematic bits are input to a second LDPC encoder to perform second encoding to generate second parity bits and store them in a second circular buffer. The second LDPC encoder uses the same LDPC parity check matrix as the first LDPC encoder, but since the order of the input systematic bits is interleaved, second parity bits different from the first parity bits are generated. Through this, two different parity bit sets are generated for the same information, and at the receiving side, the belief propagation range is expanded and the channel coding gain increases. The second circular buffer can also store data encoded at a code rate of 1/3.

In step 1040, data from the first circular buffer is transmitted at the first transmission point, and data from the second circular buffer is transmitted at the second transmission point, wherein the circular buffer starting point is set to enable self-decoding at the receiving side for data transmitted from each transmission point. The first transmission point and the second transmission point may transmit data simultaneously or at different times. Data transmitted from each transmission point includes both systematic bits and parity bits, enabling independent decoding at the receiving side with data from only one transmission point.

In one embodiment, the circular buffer transmission starting point of the first transmission point is 0 when rvid is 0, and may be a position calculated according to the LDPC base graph when rvid is 1. For LDPC base graph 1, it is └(44Ncb)/(66Zc)┘Zc, and for LDPC base graph 2, it may be └(33Ncb)/(50Zc)┘Zc. Here, Ncb is the number of bits that go into the circular buffer, and Zc is a value determined according to the number of information bits to be encoded and the code rate.

In another embodiment, the circular buffer transmission starting point of the second transmission point may also be set in the same way. When rvid is 0, it is 0, and when rvid is 1, transmission starts from a position calculated according to the LDPC base graph. The first transmission point and the second transmission point use the same starting point calculation formula for the same rvid value, but use different circular buffers, so the content of the transmitted data is different.

In yet another embodiment, the first parity bits and the second parity bits have different values due to the interleaver, through which the code rate is lowered and the channel coding gain increases. When the receiving side receives data from both transmission points, combining two sets of parity bits for decoding results in a substantially lower code rate, providing strong error correction capability.

In yet another embodiment, the multi-transmission point scheme is particularly useful in environments with high propagation blocking probability, such as high-frequency environments like FR2 or cell edges. Even if the signal from one transmission point is blocked by obstacles, the signal from the other transmission point can be received, reducing link failure probability and compensating for propagation loss. In addition, since data transmitted from each transmission point can be independently decoded, unnecessary retransmissions can be prevented and overall system throughput can be improved.

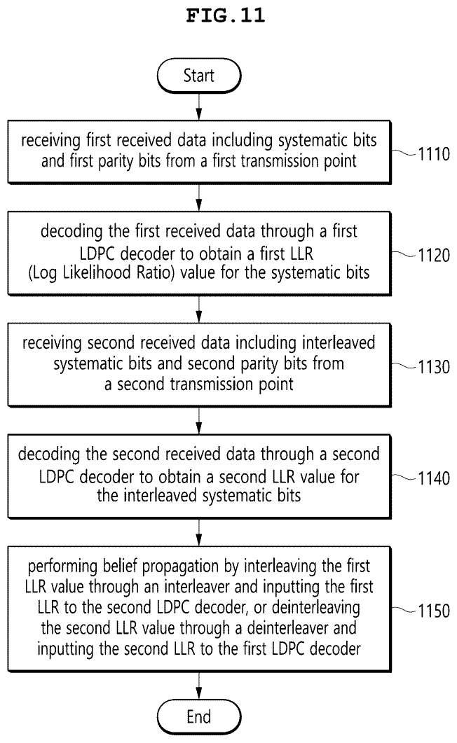

FIG. 11 is a flowchart showing the operation method of a receiving apparatus at multiple transmission points according to an embodiment of the present disclosure.

Referring to FIG. 11, the receiving apparatus operates in the following steps.

In step 1110, the receiving apparatus receives first received data including systematic bits and first parity bits from a first transmission point. The first transmission point may be referred to as TRP1 and transmits data encoded with non-interleaved systematic bits. The first received data may be received through PDSCH and includes both systematic bits and first parity bits, enabling independent decoding. The receiving apparatus may obtain channel state information by measuring the signal quality from the first transmission point.

In step 1120, the receiving apparatus decodes the first received data through a first LDPC decoder to obtain a first LLR (Log Likelihood Ratio) value for the systematic bits. The first LDPC decoder performs a belief propagation algorithm based on the LDPC parity check matrix. During the decoding process, an LLR value is calculated for each systematic bit, which represents the log-likelihood ratio of the probability that the bit is 0 or 1. The first LDPC decoder improves the reliability of each bit by iteratively updating the LLR values. When decoding is completed, whether there is an error can be checked through a CRC check.

In step 1130, the receiving apparatus receives second received data including interleaved systematic bits and second parity bits from a second transmission point. The second transmission point may be referred to as TRP2 and transmits data encoded with interleaved systematic bits. The second received data also includes both systematic bits and second parity bits, enabling independent decoding. The first received data and the second received data may be received simultaneously or at different times. The receiving apparatus may use multiple antenna or beamforming technology to receive signals from the two transmission points separately.

In step 1140, the receiving apparatus decodes the second received data through a second LDPC decoder to obtain a second LLR value for the interleaved systematic bits. The second LDPC decoder also performs a belief propagation algorithm based on the LDPC parity check matrix. Since the second received data includes systematic bits in interleaved order, the second LDPC decoder calculates LLR values according to the interleaved order. Whether there is an error in the decoding result of the second LDPC decoder can also be checked through a CRC check. If the CRC of the second received data is in error, the second LLR is deinterleaved and exchanged as input to the first decoder. LLR exchange between the first and second decoders is performed repeatedly and iteration is terminated when the CRC passes. Through this, the belief propagation range is expanded to improve decoding reliability.

In step 1150, the receiving apparatus performs belief propagation by interleaving the first LLR value through an interleaver and inputting it to the second LDPC decoder, or deinterleaving the second LLR value through a deinterleaver and inputting it to the first LDPC decoder. This step is a process of improving decoding performance through LLR value exchange between the two decoders. Interleaving the first LLR value makes it match the systematic bit order used by the second decoder, so it can be used as additional information in the decoding process of the second decoder. Likewise, deinterleaving the second LLR value restores it to the original systematic bit order, so it can be used in the decoding process of the first decoder. This LLR value exchange can be performed repeatedly, and the reliability of the systematic bits increases with each iteration.

In one embodiment, the first received data and the second received data may be received simultaneously and combined for decoding. In this case, since parity bits from both transmission points are used, the effective code rate is lowered, providing strong error correction capability. The receiving apparatus may derive the final decoding result by combining two sets of LLR values. In another embodiment, data received from each of the first transmission point and the second transmission point can be independently decoded. Even if data from one transmission point is not received due to propagation blocking, decoding is possible with only data from the other transmission point. Through this, stable communication can be guaranteed even in environments with high propagation blocking probability. For example, if the signal from the first transmission point is blocked by obstacles and only the signal from the second transmission point is received, independent decoding can be performed in the second LDPC decoder using only the second received data.

In yet another embodiment, the multi-transmission point reception scheme is particularly effective in FR2 environments or at cell edges. In high-frequency environments like FR2, the diffraction of electromagnetic waves is low, so the blocking probability due to obstacles is high, but spatial diversity can be secured through multiple transmission points to greatly reduce link failure probability. In addition, by applying the interleaver-based retransmission scheme of the present disclosure, the belief propagation range is expanded, channel coding gain increases, and the throughput and reliability of the overall system are improved.

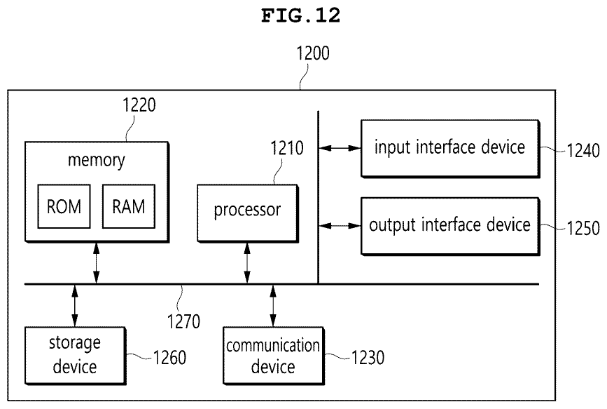

In yet another embodiment, the receiving apparatus may be a terminal (UE) of the 3GPP 5G NR system and includes a transceiver and a processor. The processor may include or be configured to perform the functions of a first LDPC decoder, a second LDPC decoder, an interleaver, and a deinterleaver. The receiving apparatus may store decoding algorithms and LLR values in memory, and the processor may process them to restore final data. FIG. 12 is a block diagram showing the internal configuration of a transmitting apparatus and a receiving apparatus according to an embodiment of the present disclosure.

FIG. 12 is a block diagram showing the internal configuration of a transmitting apparatus and a receiving apparatus according to an embodiment of the present disclosure.

Referring to FIG. 12, the communication device 1200 may include at least one processor 1210, memory 1220, and communication device 1230 connected to a network to perform communication. In addition, the communication device 1200 may further include an input interface device 1240, an output interface device 1250, a storage device 1260, and the like. Each component included in the communication device 1200 is connected by a bus 1270 and can communicate with each other.

However, each component included in the communication device 1200 may be connected through individual interfaces or individual buses centered on the processor 1210, rather than the common bus 1270. For example, the processor 1210 may be connected to at least one of the memory 1220, the communication device 1230, the input interface device 1240, the output interface device 1250, and the storage device 1260 through a dedicated interface.

The processor 1210 may execute program commands stored in at least one of the memory 1220 and the storage device 1260. The processor 1210 may refer to a central processing unit (CPU), a graphics processing unit (GPU), or a dedicated processor on which methods according to embodiments of the present disclosure are performed. Each of the memory 1220 and the storage device 1260 may be composed of at least one of a volatile storage medium and a non-volatile storage medium. For example, the memory 1220 may be composed of at least one of read only memory (ROM) and random access memory (RAM).

The communication device 1230 may be referred to as a transceiver and may perform wireless or wired communication. The communication device 1230 may support physical layer communication of the 3GPP 5G NR system and may transmit and receive data through channels such as PDSCH, PUSCH, and PDCCH. The communication device 1230 may operate in FR1 or FR2 frequency bands and may support multiple antenna or beamforming technology.

When the communication device 1200 is a transmitting apparatus, the processor 1210 may be configured to perform the following functions. The processor 1210 may generate first parity bits by encoding systematic bits through a first LDPC encoder, and may generate second parity bits by interleaving the systematic bits through an interleaver and then encoding them through a second LDPC encoder. The first LDPC encoder and the second LDPC encoder may be implemented as software within the processor 1210 or as separate hardware accelerators. The interleaver may also be implemented within the processor 1210 or as separate hardware.

The processor 1210 may configure a first circular buffer and a second circular buffer in the memory 1220 or the storage device 1260 and store encoded data in each circular buffer. The processor 1210 may determine the starting point of the circular buffer according to the redundancy version identifier, select data to transmit, and transmit it through the communication device 1230. In the single transmission point scheme, even-numbered transmissions and odd-numbered transmissions are performed separately in time, and in the multi-transmission point scheme, transmission can be performed simultaneously or sequentially through the first transmission point and the second transmission point.

When the communication device 1200 is a receiving apparatus, the processor 1210 may be configured to perform the following functions. The processor 1210 may decode data received through the communication device 1230 through a first LDPC decoder and a second LDPC decoder. The first LDPC decoder and the second LDPC decoder perform a belief propagation algorithm to calculate LLR values for systematic bits. The processor 1210 may use an interleaver and a deinterleaver to exchange LLR values between the two decoders, thereby improving decoding performance.

The processor 1210 may perform a CRC check to determine whether the decoding result has errors and may request retransmission as necessary. In the single transmission point scheme, even-numbered receptions and odd-numbered receptions are processed separately, and in the multi-transmission point scheme, data from the first transmission point and the second transmission point may be decoded separately or combined for decoding.

The memory 1220 may store the LDPC parity check matrix, interleaving pattern, intermediate decoding results such as LLR values, etc. The storage device 1260 may store communication protocols, LDPC encoding/decoding algorithms, circular buffer management programs, etc.

The input interface device 1240 may receive data or control commands from the user, and the output interface device 1250 may output decoding results or communication status information.

In one embodiment, the communication device 1200 may be a base station (gNB) or a terminal (UE) of the 3GPP 5G NR system. In the case of a base station, it can manage and control multiple transmission points, and in the case of a terminal, it can receive and process signals from multiple transmission points.

In another embodiment, the communication device 1200 may be configured to perform the methods described in FIGS. 8, 9, 10, and 11 of the present disclosure. That is, it may perform at least one of a single transmission point transmission method, a single transmission point reception method, a multi-transmission point transmission method, and a multi-transmission point reception method.

In yet another embodiment, the communication device 1200 may detect an environment with high propagation blocking probability and selectively apply the retransmission scheme of the present disclosure accordingly. For example, the channel state may be determined based on measured values such as RSSI, RSRP, RSRQ, and SINR, and if the propagation blocking probability is determined to be high, the scheme of the present disclosure that enables self-decoding for each transmission may be applied.

Methods according to embodiments described in the claims or specification of the present disclosure may be implemented in the form of hardware, software, or a combination of hardware and software. When implemented as software, a computer-readable storage medium storing one or more programs (software modules) may be provided. One or more programs stored in the computer-readable storage medium are configured for execution by one or more processors in an electronic device.

The one or more programs include instructions that cause the electronic device to execute methods according to embodiments described in the claims or specification of the present disclosure. These programs (software modules, software) may be stored in random access memory, non-volatile memory including flash memory, read only memory (ROM), electrically erasable programmable read only memory (EEPROM), magnetic disc storage device, compact disc-ROM (CD-ROM), digital versatile discs (DVDs) or other forms of optical storage devices, or magnetic cassettes. Alternatively, they may be stored in memory composed of some or all combinations thereof. In addition, each configuration memory may be included in plural.

In addition, the program may be stored in an attachable storage device that can be accessed through a communication network such as the Internet, Intranet, local area network (LAN), wide area network (WAN), or storage area network (SAN), or a communication network composed of combinations thereof. Such a storage device may access a device performing embodiments of the present disclosure through an external port. In addition, a separate storage device on the communication network may access a device performing embodiments of the present disclosure. In the specific embodiments of the present disclosure described above, components included in the disclosure were expressed in singular or plural according to the specific embodiment presented. However, the singular or plural expression is selected appropriately for the situation presented for convenience of description, and the present disclosure is not limited to singular or plural components, and even components expressed in plural may be composed in singular, or even components expressed in singular may be composed in plural. Meanwhile, although specific embodiments have been described in the detailed description of the present disclosure, various modifications are possible without departing from the scope of the present disclosure. Therefore, the scope of the present disclosure should not be limited to the described embodiments but should be determined by the claims described below as well as by what is equivalent to these claims.

What is claimed is:

1. A method of operating a transmitting apparatus for retransmitting data encoded with a Low Density Parity Check (LDPC) code in a wireless communication system, the method comprising:
inputting systematic bits to a first LDPC encoder to perform first encoding to generate first parity bits and storing them in a first circular buffer;
interleaving the systematic bits through an interleaver to generate interleaved systematic bits; inputting the interleaved systematic bits to a second LDPC encoder to perform second encoding to generate second parity bits and storing them in a second circular buffer;
in even-numbered transmissions, transmitting data including systematic bits and first parity bits from the first circular buffer and setting a circular buffer starting point to enable self-decoding at a receiving side; and in odd-numbered transmissions,
transmitting data including interleaved systematic bits and second parity bits from the second circular buffer and setting a circular buffer starting point to enable self-decoding at the receiving side.

2. The method of claim 1, wherein: the even-numbered transmission is performed from the first circular buffer; in a first transmission, transmission is performed from a starting position of the first circular buffer; and
in a third transmission, transmission is performed from a position set to include both systematic bits and parity bits within the first circular buffer, enabling independent decoding at the receiving side for each transmission.

3. The method of claim 1, wherein: the odd-numbered transmission is performed from the second circular buffer;
in a second transmission, transmission is performed from a starting position of the second circular buffer; and
in a fourth transmission, transmission is performed from a position set to include both interleaved systematic bits and parity bits within the second circular buffer, enabling independent decoding at the receiving side for each transmission.

4. The method of claim 1, wherein the data transmitted in the even-numbered transmission and the odd-numbered transmission is transmitted at a higher code rate than the data stored in the first circular buffer and the second circular buffer, configured to enable self-decoding while increasing transmission efficiency.

5. The method of claim 1, wherein: the wireless communication system is a 3GPP 5G NR system; and
the transmission is performed through a Physical Downlink Shared Channel (PDSCH) or a Physical Uplink Shared Channel (PUSCH).

6. A method of operating a receiving apparatus for receiving data encoded with a Low Density Parity Check (LDPC) code in a wireless communication system, the method comprising:
receiving first received data including systematic bits and first parity bits in an even-numbered transmission; decoding the first received data through a first LDPC decoder to obtain a first Log Likelihood Ratio (LLR) value for the systematic bits;
when a Cyclic Redundancy Check (CRC) check result of the first received data indicates an error, interleaving the first LLR value through an interleaver;
receiving second received data including interleaved systematic bits and second parity bits in an odd-numbered transmission; and
inputting the second received data and the interleaved first LLR value to a second LDPC decoder to perform decoding.

7. The method of claim 6, further comprising:
obtaining a second LLR value for the systematic bits as a result of decoding by the second LDPC decoder;
when a CRC check result of the second received data indicates an error, deinterleaving the second LLR value through a deinterleaver; and
inputting the deinterleaved second LLR value to the first LDPC decoder to improve reliability.

8. The method of claim 6, wherein each of the first received data and the second received data can be independently decoded without using previously received data.

9. The method of claim 6, wherein decoding reliability is improved by expanding a belief propagation range through exchange of the first LLR value and the second LLR value.

10. The method of claim 6, wherein: the wireless communication system is an environment with high propagation blocking probability; and
the receiving apparatus determines the propagation blocking probability based on at least one of Received Signal Strength Indicator (RSSI), Reference Signal Received Power (RSRP), Reference Signal Received Quality (RSRQ), or Signal to Interference plus Noise Ratio (SINR).

11. A method of operating a transmitting apparatus for transmitting data encoded with a Low Density Parity Check (LDPC) code using multiple Transmission-Reception-Points (multi-TRP) in a wireless communication system, the method comprising:
at a first transmission point, inputting systematic bits to a first LDPC encoder to perform first encoding to generate first parity bits and storing them in a first circular buffer;
at a second transmission point, interleaving the systematic bits through an interleaver to generate interleaved systematic bits; at the second transmission point,
inputting the interleaved systematic bits to a second LDPC encoder to perform second encoding to generate second parity bits and storing them in a second circular buffer; and
transmitting data from the first circular buffer at the first transmission point and transmitting data from the second circular buffer at the second transmission point,
wherein a circular buffer starting point is set to enable self-decoding at a receiving side for data transmitted from each transmission point.

12. The method of claim 11, wherein: the first transmission point transmits data from a starting position of the first circular buffer during a first transmission; and
during retransmission, transmits data from a position set to include both systematic bits and parity bits within the first circular buffer,
enabling independent decoding at the receiving side for each transmission.

13. The method of claim 11, wherein: the second transmission point transmits data from a starting position of the second circular buffer during a first transmission; and
during retransmission, transmits data from a position set to include both interleaved systematic bits and parity bits within the second circular buffer,
enabling independent decoding at the receiving side for each transmission.

14. The method of claim 11, wherein the first parity bits and the second parity bits have different values due to the interleaver.
